(19) United States
(12) Patent Application Publication
(10) Pub. No.: US 2014/0171528 A1
(43) Pub. Date: Jun. 19, 2014

(54) MULTI-FUNCTIONAL BIO POLYURETHANE FOAM

(71) Applicants: HYUNDAI MOTOR COMPANY, Seoul (KR); HYUNDAI DYMOS INCORPORATED, Seosan (KR)

(72) Inventors: Seok-Hwan Kim, Gunpo (KR); Jeong Seok Oh, Yongin (KR); Sang-Ho Seo, Osan (KR); Hyung-Won Jeon, Daejeon (KR)

(73) Assignees: HYUNDAI DYMOS INCORPORATED, Seosan (KR); HYUNDAI MOTOR COMPANY, Seoul (KR)

(21) Appl. No.: 13/873,555

(22) Filed: Apr. 30, 2013

(30) Foreign Application Priority Data
Dec. 18, 2012 (KR) 10-2012-0148830

(51) Int. Cl. C08G 18/68

(52) U.S. Cl. CPC C08G 18/68
USPC 521/122; 521/172

(57) ABSTRACT

Disclosed is a multi-functional bio polyurethane foam, and more specifically a multi-functional bio polyurethane foam which is polyurethane foam comprising a reaction product of a resin premix, which comprises about 5 to 20 wt % biopolyol, and isocyanate. The multi-functional bio polyurethane foam may be applied to a car seat and the like, and shows the same level of physical properties as the conventional polyurethane foam manufactured from the petroleum-based polyol, and further provides enhanced antimicrobial function and minimized vibration transmissivity.

### CROSS-REFERENCE TO RELATED APPLICATION

The present application claims priority to Korean Patent Application No. 10-2012-0148830, filed on Dec. 18, 2012, the entire contents of which is incorporated herein for all purposes by this reference.

### BACKGROUND

(a) Technical Field

The present invention relates to a polyurethane foam, and more specifically to a multi-functional bio polyurethane foam, which can be applied to a vehicle seat and the like, and which provides a comparable level of physical properties as the conventional polyurethane foam manufactured from a petroleum-based polyol, and which provides enhanced antimicrobial function and minimized vibration transmissivity.

(b) Background Art

Due to the continuous increase of international crude oil prices, there is a crisis in petrochemical industries that depending upon petroleum resources. Further, regulations on greenhouse gas emissions are continually being strengthened due to global warming caused by consumption of petroleum resources. Thus, active studies are underway for lowering the degree of dependence upon petroleum resources, including for example, biotechnology studies.

Herein, the biotechnology refer to a technology using biomass, which is repeatedly produced by photosynthesis of plants in the natural world, as a raw material. Such biotechnology, unlike the previous chemical industry-based technologies which depending on fossil materials such as the petroleum resources, can include new bio-chemistry fused-type technologies, which can provide sustainable growth and survival of the human race by replacing a portion or many portions of the previous chemical industries.

When comparing the greenhouse gas emissions of the products using the petrochemical materials and bio materials in terms of environmental pollution, the petrochemical material-based products go through processes of petrochemical purification, transfer of the purified material, production of products, transfer of the produced products, and then discarding of the products. In these processes, a significant amount of greenhouse gas is particularly emitted during the processes of petrochemical purification, and the production and the discard of the products.

On the other hand, the bio material-based products go through processes of plant growth, transfer of the plant-based raw materials, reduction of greenhouse gas, transfer, and biodegradation and discarding of the products. In these processes, the greenhouse gas is absorbed during the production of the raw materials, and is reduced during the production and the discarding of the products. Accordingly, the bio material-related technologies are of growing importance in terms of effectively responding to a carbon tax scheme according to carbon dioxide reduction, improvement of products' competitiveness and the prime cost increase of the petroleum resources.

These bio material-based technologies are continuing to make progress in the midst of a paradigm shift of the 21^{st} century type chemical industries, which are seeking to become more eco-friendly and to provide sustainable growth, particularly in light of trends of the chemical industries towards the development and production of bio-plastic using the biomass as a raw material. Such trends address the needs of cost reduction and protection of the environment.

Particularly, various kinds of vegetable oil-based biopolyol are being developed in a variety of countries based on the available vegetable raw materials. In particular, various kinds of biopolyols, for example soybean oil-based polyols in US, palm oil-based polyols in Malaysia, castor oil and sunflower oil-based polyols in Europe, have been developed and are being marketed.

However, the polyols applied to a car seat and the like are required to have higher molecular weight than that provided by most of the vegetable oils (vegetable oil-based biopolyols), which generally have lower molecular weight than the conventional polyol. Accordingly, when the vegetable oil-based biopolyols were applied to the polyurethane foam for the car seat and the like, there was a problem of breakdown of the foam or deterioration of physical properties due to unreacted materials contained in the biopolyols.

Further, when conducting a chemical process to remove the unreacted materials contained in the biopolyols, there were problems in that the production cost was by the additional chemical process, and the advantage of reduction of greenhouse gas emissions by using the bio materials was eliminated by addition of the chemical process.

With continued developments in the automobile industry, drivers and passengers are spending more and more time in vehicles. As such, the importance of riding quality in a car is likewise becoming increasingly important. In particular, the comfort of a car seat is closely related to the riding quality inside a car. However, with the application of conventional polyurethane foam to a car seat, the vibration transmissivity increases, which can reduce comfort.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with prior art, and provides a multi-functional bio polyurethane foam, which has enhanced antimicrobial function and excellent comfort. In particular, the multi-functional bio polyurethane foam minimizes vibration transmissivity and further provides the same level of shape and physical properties as a polyurethane foam manufactured by a polymerization reaction using a conventional petroleum-based polyol.

According to one aspect, the present invention provides a multi-functional bio polyurethane foam comprising a reaction product of a resin premix and isocyanate. In particular, the resin premix comprises a biopolyol in an amount of about 5 to 20 wt %, based on total weight of the resin premix.

According to various embodiments, the isocyanate comprises a combination of one or more of monomeric methylene diphenyl diisocyanate (MMDI), carbodiimide modified methylene diphenyl diisocyanate, polymeric methylene diphenyl diisocyanate (PMDI) and toluene diisocyanate (TDI). In a preferred embodiment, the isocyanate comprises about 10 to 70 wt % MMDI, about 10 to 70 wt % carbodiimide modified methylene diphenyl diisocyanate, about 10 to 90 wt % PMDI, and about 5 to 80 wt % TDI, based on total weight of the isocyanate.

According to a preferred embodiment of the present invention, the biopolyol is manufactured from castor oil.

According to various embodiments, the resin premix further comprises one or more base polyols, high molecular polyols and polymer polyols. In a preferred embodiment, the resin premix includes about 5 to 40 wt % base polyol, about 15 to 55 wt % high molecular polyol and about 3 to 40 wt % polymer polyol, based on total weight of the resin premix.

With respect to molecular weight, it is preferred that the molecular weight (MW) of the biopolyol is about 2500 to 3500, the molecular weight (MW) of the base polyol is about 5000 to 6000, and the molecular weight (MW) of the high molecular polyol is about 6500 to 7500. As the biopolyol, base polyol and high molecular polyol, and conventional polymers can suitably be used. In an exemplary embodiment, the base polyol and the high molecular polyol are individually selected from polyether polyol, polyester polyol or a combination thereof.

According to various embodiments, the resin premix further comprises one or more of a chain extender, a cross-linker, and a silicone surfactant. In a preferred embodiment, the resin premix includes about 0.1 to 1 wt % of one or more chain extender, more than 0 to less than about 5 wt % of one or more cross-linker and about 0.1 to 3 wt % of one or more silicone surfactant, based on total weight of the resin premix.

According to an exemplary embodiment of the present invention, the silicone surfactant comprises a first silicone surfactant and a second silicone surfactant, the second silicone surfactant having relatively stronger activity than the first silicone surfactant.

According to various embodiments, the resin premix further comprises one or more of a blowing agent a gelling catalyst, and a blowing catalyst. In a preferred embodiment, the resin premix includes about 1 to 5 wt % of a blowing agent, about 0.1 to 3 wt % of a gelling catalyst, and about 0.1 to 3 wt % blowing catalyst.

According to another aspect, the present invention provides a vehicle seat manufactured using the multi-functional bio polyurethane foam.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a picture showing conventional biopolyol-based polyurethane foam comprising biopolyol of 10 wt % based on weight of a resin premix;

FIG. 2 is a picture showing conventional biopolyol-based polyurethane foam comprising biopolyol of 20 wt % based on weight of a resin premix;

FIG. 3 is a picture showing conventional biopolyol-based polyurethane foam comprising biopolyol of 30 wt % based on weight of a resin premix;

FIG. 4 is a picture of measuring vibration transmissivity by using a vibration transmission measuring device according to one embodiment of the present invention; and

FIG. 5 is a graph showing the results of measuring vibration transmissivity of Comparative Example 1 and Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention now will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In one aspect, the present invention relates to a multi-functional bio polyurethane foam, which has enhanced antimicrobial function and excellent vibration absorbing performance. According to preferred embodiments, the enhanced antimicrobial function is provided through is of a biopolyol, and excellent vibration absorbing performance is provided by optimizing a molecular weight of polyol and isocyanate components.

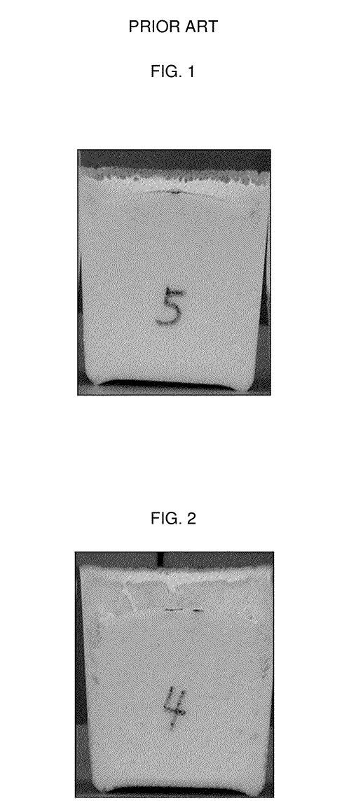

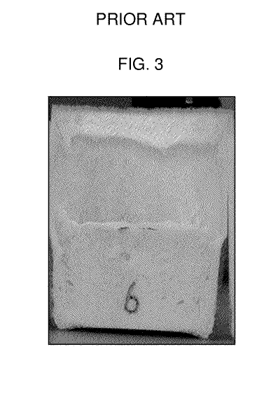

FIG. 1 to FIG. 3 are pictures showing conventional biopolyol-based polyurethane foams comprising a biopolyol of 10 wt %, 20 wt % and 30 wt % based on weight of the resin premix, respectively. As shown therein, as the amount of the biopolyol increases, unreacted material contained in the biopolyol also increases. As a result, the foam breaks down physical properties are severely reduced.

For example, a conventional foam uses a castor oil-based biopolyol comprising ricinoleic acid as a major ingredient, and further comprises stearic acid, linoleic acid, oleic acid and the like. In the conventional foam, the ingredients other than the ricinoleic acid exist as unreacted materials and thereby prevent formation of a normal foam.

The present invention provides a multi-functional bio polyurethane foam, which demonstrates the same level of shape and physical properties as the conventional petroleum polyol-based polyurethane foam. This can be accomplished by introducing high molecular polyol, a cross-linker, a chain extender, a highly active silicone surfactant and the like to the composition. The multi-functional bio polyurethane foam of the present invention further provides an enhanced antimicrobial function through the unreacted materials of the foam. The multi-functional bio polyurethane foam of the present invention further provides minimized vibration transmissivity due to excellent vibration absorbing performance which is obtained by optimizing molecular weights of polyol components of the foam and by controlling an isocyanate composition.

Specifically, the present invention relates to a polyurethane foam comprising the reaction product of a resin premix and the isocyanate. The resin premix can include a biopolyol in an amount of about 5 to 20 wt % based on weight of the resin premix. The resin premix can further include other polyols and additives. Accordingly, hereinafter, those components will be described in further detail.

(A) Biopolyol

The biopolyol means a polyol manufactured by using vegetable oil extracted from seeds or fruits of various plants, animal oil from various kinds of fish-based oil, and the like. Such biopolyols are unlike polyether polyols and polyester polyols, which are manufactured from a petrochemical raw material. According to various embodiments, the biopolyol preferably has a molecular weight (MW) of about 2500 to 3500 to provide desired vibration transmissivity properties.

Particularly, the biopolyol according to the present invention can be manufactured from the vegetable oil having eco-friendly effect by use of any common known method. According to various embodiments, it is preferred that the vegetable oil is at least one selected from the group consisting of castor oil, soybean oil, palm oil, canola oil and sunflower oil. According to a preferred embodiment, the vegetable oil is castor oil.

The biopolyol is preferably contained in an amount of about 5 to 20 wt % based on total weight of the resin premix. When the amount is less than about 5 wt %, the effect obtained by adding the biopolyol (i.e., reduction of greenhouse gas emissions and the antimicrobial effect), which will be mentioned below, may be meager. On the other hand, when the amount exceeds about 20 wt %, the foam may be hardly formed, and physical properties may be deteriorated. Accordingly, it is preferred to satisfy the said range.

(B) Isocyanate

The isocyanate, which is generally used for manufacturing the polyurethane foam, preferably comprises methylene diphenyl diisocyanate (MDI), toluene diisocyanate (TDI) or a combination thereof. According to a particularly preferred embodiment, the isocyanate has the composition of the following Table 1 which provides particularly improved vibration absorbing performance.

TABLE 1

| Components | Composition |
|---|---|
| Monomeric methylene diphenyl diisocyanate | 10~70 wt % |
| (Monomeric MDI, MMDI) | |
| Carbodiimide modified MDI | 10~70 wt % |
| Polymeric methylene diphenyl diisocyanate | 10~90 wt % |
| (Polymeric MDI, PMDI) | |
| Toluene diisocyanate (TDI) | 5~80 wt % |

As shown in Table 1, the isocyanate according to the present invention preferably comprises monomeric methylene diphenyl diisocyanate (MMDI) in an amount of about 10 to 70 wt %, carbodiimide modified methylene diphenyl diisocyanate in an amount of about 10 to 70 wt %, polymeric methylene diphenyl diisocyanate (PMDI) in an amount of about 10 to 90 wt % and toluene diisocyanate (TDI) in an amount of about 5 to 80 wt %, based on total weight of the isocyanate.

According to a preferred embodiment, the monomeric methylene diphenyl diisocyanate (MMDI) and the carbodiimide modified methylene diphenyl diisocyanate are each added in an amount of about 10 to 70 wt %, respectively. When the amount based on the total weight of the isocyanate is less than about 10 wt %, the productivity may be deteriorated due to overproduction of closed cells. On the other hand, when the amount exceeds about 70 wt %, the foam may not be produced due to overproduction of opened cells, thereby increasing the likelihood of defect foams. Accordingly, it is preferred to satisfy the said range.

Further, it is preferred to add the polymeric methylene diphenyl diisocyanate (PMDI) in an amount of about 10 to 90 wt %. When the amount based on the total weight of the isocyanate is less than about 10 wt %, tensile strength and tearing strength may be rapidly deteriorated. On the other hand, when the amount exceeds about 90 wt %, hardness may rapidly increase. Accordingly, it is preferred to satisfy the said range.

Further, it is preferred to add the toluene diisocyanate (TDI) in an amount of about 5 to 80 wt %. When the amount based on the total weight of the isocyanate is less than about 5 wt %, resilience may be deteriorated. On the other hand, when the amount exceeds about 80 wt %, the vibration transmissivity may increase and the hardness may decrease. Accordingly, it is preferred to satisfy the said range.

According to various embodiments, the amount of the isocyanate is about 30 to 70 parts by weight, more preferably about 50 parts by weight based on 100 parts by weight of the resin premix. When the amount is less than about 30 parts by weight, cell stability of the foam may be deteriorated. On the other hand, when the amount exceeds about 70 parts by weight, the formed foam may be easily broken due to overproduction of the foam cells. Accordingly, it is preferred to satisfy the said range.

According to various embodiments, it is preferred that the resin premix further comprises a base polyol, a high molecular polyol and/or polymer polyol. In particular, it is preferred that the resin premix further comprises the base polyol of about 5 to 40 wt %, the high molecular polyol of about 15 to 55 wt % and the polymer polyol of about 3 to 40 wt %, based on total weight of the resin premix.

(C) Base Polyol

First of all, the base polyol means the conventional petroleum-based polyols and commonly known polyols, which are applied to the polyurethane foam, such as polyether polyol, polyester polyol and combinations thereof. According to the present invention, it is preferred that the base polyol has a molecular weight (MW) of about 5000 to 6000 in consideration of desired vibration transmissivity values.

It is preferred to contain this base polyol in an amount of about 5 to 40 wt % based on weight of the resin premix. When the amount is less than about 5 wt %, there may be a problem of increase of vibration transmissivity. On the other hand, when the amount exceeds about 40 wt %, compression permanent decrease rate may be deteriorated. Accordingly, it is preferred to satisfy the said range.

(D) High Molecular Polyol

Further, the high molecular polyol means commonly known polyols, which are applied to the polyurethane foam, such as polyether polyol, polyester polyol and combinations thereof. In order to improve resilience and elongation rate of the formed foam, it is preferred that the high molecular polyol has a molecular weight (MW) that is larger than the base polyol, for example a MW of about 6500 to 7500.

It is preferred to add this high molecular polyol in an amount of about 15 to 55 wt % based on total weight of the resin premix. When the amount is less than about 15 wt %, the resilience of the foam may be significantly reduced. On the other hand, when the amount exceeds about 55 wt %, the resilience may increase, thereby possibly deteriorating the comfort provided by the soft polyurethane foam. Accordingly, it is preferred to satisfy the said range.

(E) Polymer Polyol

Further, the polymer polyol, which may also be referred to as a copolymer polyol, is used for improving hardness and the like by mixed with the base polyol.

It is preferred to add the polymer polyol in an amount of about 3 to 40 wt % based on total weight of the resin premix. When the amount is less than about 3 wt %, the hardness of the foam may be significantly decreased, thereby narrowing the applicable uses for the polyurethane foam. On the other hand, when the amount exceeds about 40 wt %, the hardness and vibration transmissivity of the foam may increase, thereby deteriorating the comfort of the foam. Accordingly, it is preferred to satisfy the said range.

According to various embodiments, it is preferred that the resin premix further comprises one or more of a chain extender, a cross-linker and a silicone surfactant. In particular, it is preferred that the resin premix further comprises a chain extender in an amount of about 0.1 to 1 wt %, a cross-linker in an amount of more than 0 to less than about 5 wt % and a silicone surfactant in an amount of about 0.1 to 3 wt %.

(F) Chain Extender and Cross-Linker

The chain extender and the cross-linker are reactive monomers used for enhancing intermolecular bonding. The chain extender plays a role of extending a main chain, and in preferred embodiments, it may be mainly bivalent alcohols and/or amines. The cross-linker plays a role of making chains to form a mesh structure or branched structure in order to prevent the breakdown of the foam and to improve tensile strength, dry set and the like. In preferred embodiments, the cross-linker may be mainly trivalent alcohols or amines.

In an exemplary embodiment of the present invention, the chain extender is 1,4-butane diol (OH—V=500˜1500 mg KOH/g), and the cross-linker is triethanolamine.

Further, it is preferred to add the chain extender in an amount of about 0.1 to 1 wt % based on weight of the resin premix. When the amount is less than about 0.1 wt %, the effect of extending the main chain may be meager. On the other hand, when the amount exceeds about 1 wt %, fluidity may be deteriorated. Accordingly, it is preferred to satisfy the said range.

Further, it is preferred to add the cross-linker in an amount of more than 0 to less than about 5 wt % based on weight of the resin premix. When the amount exceeds about 5 wt %, the fluidity may be deteriorated, thereby potentially increasing the likelihood of defects. Accordingly, it is preferred to satisfy the said range.

(G) Silicone Surfactant

The silicone surfactant plays roles of facilitating the mixing of raw materials (emulsification), helping bubble growth by lowering surface tension of a urethane system, and preventing gas diffusion by lowering pressure difference between bubbles. It is preferred that the silicone surfactant includes a first silicone surfactant and a second silicone surfactant, such as set forth below.

TABLE 2

| | First Silicone | Second Silicone |
|---|---|---|
| | Surfactant | Surfactant |
| Silicone Polymer MW | Low | High |
| Branched Polyether | Low | High |
| Branched Polyethylene | High | Low |
| Ethyleneoxide (PE EO) | | |

The Table 2 is a table comparing the first silicone surfactant and the second silicone surfactant which can be used in the present invention. The first silicone surfactant means a silicone surfactant conventionally used to manufacture polyurethane foam from the conventional petroleum-based polyol, and the second silicone surfactant is a material optionally added with the first silicone surfactant and which has an effect of preventing breakdown of the foam caused by addition of the biopolyol. In particular, such effects can be provided by the second silicone surfactant because it has stronger activity than the first silicone surfactant.

It is preferred to add the silicone surfactant, comprising the first silicone surfactant and the second silicone surfactant, in an amount of about 0.1 to 3 wt % based on total weight of the resin premix. When the amount is less than about 0.1 wt %, the urethane foam may be hardly formed. On the other hand, when the amount exceeds about 3 wt %, the productivity may be deteriorated by overproduction of closed cells. Accordingly, it is preferred to satisfy the said range.

According to various embodiments, it is preferred that the resin premix comprises one or more of a blowing agent, a gelling catalyst and/or a blowing catalyst. In an exemplary embodiment, the resin premix further comprises a blowing agent in an amount of about 1 to 5 wt %, a gelling catalyst in an amount of about 0.1 to 3 wt % and a blowing catalyst in an amount of about 0.1 to 2 wt %.

(H) Blowing Agent

The blowing agent is a material used for manufacturing foam and plays a role of forming bubbles during a polymer reaction.

It is preferred to add the blowing agent in an amount of about 1 to 5 wt % based on weight of the resin premix. When the amount is less than about 1 wt %, blowing rate may be lowered, thereby making the formation of the foam difficult. On the other hand, when the amount exceeds about 5 wt %, physical properties may be deteriorated by over blowing. Accordingly, it is preferred to satisfy the said range.

(I) Gelling Catalyst and Blowing Catalyst

The gelling catalyst is a catalyst for accelerating the reaction of the polyol and the isocyanate, and it may be any conventional gelling catalysts such as organic metals (tin compound, lead compound and the like), a part of tertiary amines (TEDA) and the like. The blowing catalyst is a catalyst for accelerating saturation reaction of the isocyanate and water, and it may be any conventional gelling catalysts such as a part of tertiary amines (PMDETA, BDMEE) and the like.

It is preferred to add the gelling catalyst in an amount of about 0.1 to 3 wt % based on weight of the resin premix. When the amount is less than about 0.1 wt %, productivity may be deteriorated by a lowered curing property. On the other hand, when the amount exceeds about 3 wt %, the fluidity may be deteriorated, thereby porosity may be poor. Accordingly, it is preferred to satisfy the said range.

It is preferred to add the blowing catalyst in an amount of about 0.1 to 2 wt % based on weight of the resin premix, and the reasons for limiting the upper limit and the lower limit are same as the gelling catalyst.

The polyurethane foam of the present invention having the said composition has enhanced antimicrobial property, particularly by using the bio material, and excellent vibration absorbing performance. Further, the polyurethane foam of the present invention further demonstrates the same level of physical properties as the polyurethane foam manufactured from the conventional petroleum-based polyol. Accordingly, it can be applied to manufacture of a car seat and the like.

### Example 1

Hereinafter, the present invention will be described in further detail with reference to examples. It will be obvious to a person having ordinary skill in the art that these examples are illustrative purposes only and are not to be construed to limit the scope of the present invention.

TABLE 3

| | Comp. | Comp. | Comp. | | | |
|---|---|---|---|---|---|---|
| | Exam. 1 | Exam. 2 | Exam. 3 | Exam. 1 | Exam. 2 | Exam. 3 |
| | (wt %) | (wt %) | (wt %) | (wt %) | (wt %) | (wt %) |
| Base Polyol | 66.66 | 56.66 | 46.66 | 18.64 | 8.64 | 28.64 |
| (MW 5500) | | | | | | |
| Bio Polyol | — | — | — | 18.64 | 18.64 | 18.64 |
| (MW 3000) | | | | | | |
| High | — | 10.0 | 20.0 | 27.96 | 37.96 | 17.96 |
| Molecular | | | | | | |
| Polyol | | | | | | |
| (MW 7000) | | | | | | |
| Polymer | 28.57 | 28.57 | 28.57 | 27.96 | 27.96 | 27.96 |
| Polyol | | | | | | |
| Blowing | 0.29 | 0.29 | 0.29 | 0.28 | 0.28 | 0.28 |
| Catalyst | | | | | | |
| Gelling | 0.67 | 0.67 | 0.67 | 0.65 | 0.65 | 0.65 |
| Catalyst | | | | | | |
| Cross-linker | — | — | — | 0.65 | 0.65 | 0.65 |
| Chain | — | — | — | 1.40 | 1.40 | 1.40 |
| Extender | | | | | | |
| First | 0.95 | 0.95 | 0.95 | 0.74 | 0.74 | 0.74 |
| Silicone | | | | | | |
| Surfactant | | | | | | |
| Second | — | — | — | 0.28 | 0.28 | 0.28 |
| Silicone | | | | | | |
| Surfactant | | | | | | |
| Blowing | 2.86 | 2.86 | 2.86 | 2.80 | 2.80 | 2.80 |
| Agent | | | | | | |

The above Table 3 is a table comprising the compositions of the resin premixes manufactured from the conventional petroleum-based polyol (Comparative Examples 1 to 3) and the resin premixes manufactured from the biopolyol according to the present invention (Examples 1 to 3). Polyurethane foams were manufactured by using the resin premix having the described compositions and the isocyanate according to the present invention according to a common known method. The physical properties of the manufactured foams were measured, and the results are listed in the following Table 4.

TABLE 4

| | Comp. | Comp. | Comp. | | | |
|---|---|---|---|---|---|---|
| | Exam. | Exam. | Exam. | Exam. | Exam. | Exam. |
| | 1 | 2 | 3 | 1 | 2 | 3 |
| Hardness | 66.66 | 56.66 | 46.66 | 18.64 | 8.64 | 28.64 |
| (ILD) | | | | | | |
| Resilience | — | — | — | 18.64 | 18.64 | 18.64 |
| (%) | | | | | | |
| Tensile | — | 10.0 | 20.0 | 27.96 | 37.96 | 17.96 |
| (kgf/cm²) | | | | | | |
| Elongation | 28.57 | 28.57 | 28.57 | 27.96 | 27.96 | 27.96 |
| Rate (%) | | | | | | |

As shown in Table 4, it was demonstrated that, although the polyurethane foam according to the present invention contained the biopolyol in an amount of up to 20 wt % based on the weight of the resin premix, it showed the same level of shape and physical properties as the polyurethane foam manufactured from the conventional petroleum-based polyol.

In addition, the antimicrobial effect of the polyurethane foam according to the present invention was enhanced by the unreacted materials (except the ricinoleic acid in the biopolyol). Accordingly, it will be observed in detail.

TABLE 5

| | | | Comparative | |
|---|---|---|---|---|
| Section | | Blank | Example 1 | Example 1 |
| Staphylococcus | Initial Bacteria | 2.0 × 10\hat{ }4 | 2.0 × 10\hat{ }4 | 2.0 × 10\hat{ }4 |
| aureus | Number/ml | | | |
| | 18 hrs later/ml | 2.2 × 10\hat{ }6 | 1.3 × 10\hat{ }6 | 1.6 × 10\hat{ }4 |
| | Bacteria | — | 40.9% | 99.3% |
| | Reduction | | | |
| | Rate | | | |
| Klebsiella | Initial Bacteria | 2.5 × 10\hat{ }4 | 2.5 × 10\hat{ }4 | 2.5 × 10\hat{ }4 |
| pneumoniae | Number/ml | | | |
| | 18 hrs later/ml | 1.6 × 10\hat{ }6 | 8.5 × 10\hat{ }6 | 8.3 × 10\hat{ }4 |
| | Bacteria | — | 46.9% | 48.1% |
| | Reduction | | | |
| | Rate | | | |

The above Table 5 is a table comparing the antimicrobial effect of the polyurethane foam manufactured from the conventional petroleum-based polyol and the polyurethane foam according to the present invention. In particular, the number of bacteria was measured after injecting solutions containing Staphylococcus aureus (ATCC 6538) and Klebsiella pneumoniae (ATCC 4352) in an amount of 0.2 cc, respectively, to a sample, followed by keeping at 37° C. for 18 hours.

(Test Institute: FITI testing and research institute, Test Standard: KS K 0693-2006 antibacterial activity)

As shown in the above table, it was confirmed that the polyurethane foam according to the present invention showed significantly improved antimicrobial effect as compared to the conventional polyurethane foam. This improvement was caused by the unreacted materials in the biopolyol. Further, it was found that the physical properties of the foam were maintained even though the unreacted materials were in the biopolyol.

TABLE 6

| | Comp. | Comp. | Comp. | | | |
|---|---|---|---|---|---|---|
| | Exam. | Exam. | Exam. | Exam. | Exam. | Exam. |
| | 1 | 2 | 3 | 1 | 2 | 3 |
| Vibration | 6.4 | 6.8 | 7.1 | 3.2 | 4.1 | 3.8 |
| Transmissivity | | | | | | |

The vibration transmissivity is a value calculated by dividing all vibration transmitted to a seat during driving by vibration a driver receives, and as the value becomes lower, dynamic comfort is improved by the absorption of more vibration by the seat.

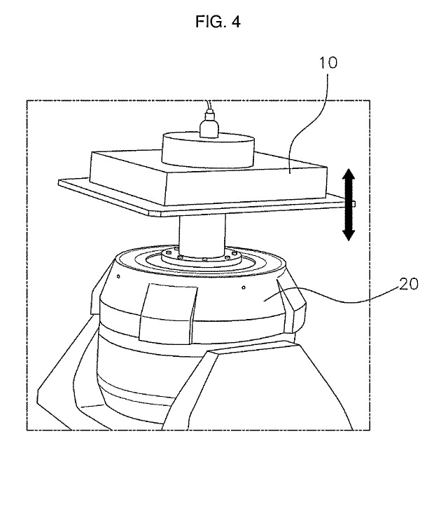

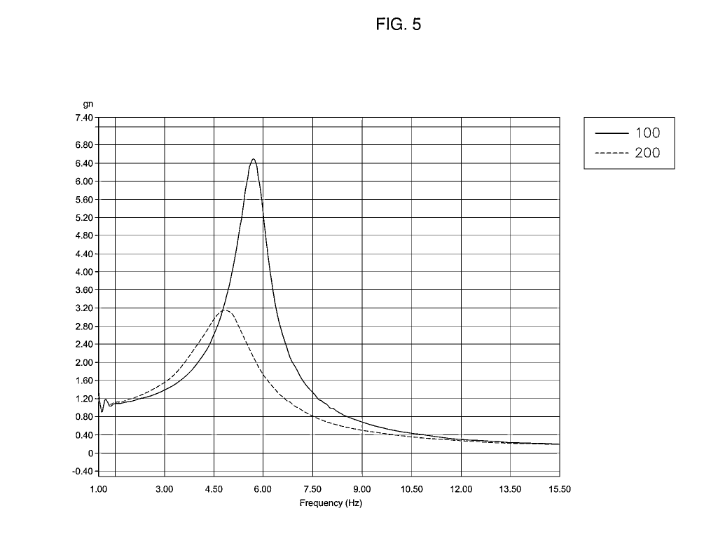

The Table 6 is a table comparing the vibration transmissivity of the polyurethane foam manufactured from the conventional petroleum-based polyol and the polyurethane foam according to the present invention. As shown in FIG. 4, the vibration transmissivity was measured by artificially transferring vibration to the urethane foam by using a vibration transmission measuring device. The results of Comparative Example 1 and Example 1 are representatively shown in the graph of FIG. 5.

As described above, it was confirmed that the vibration transmissivity of the polyurethane foam according to the present invention was significantly lowered compared with the vibration transmissivity of the polyurethane foam manufactured from the conventional petroleum-based polyol. This means that the polyurethane foam according to the present invention has excellent vibration absorbing performance, and it also shows excellent comfort when applied to a car seat and the like.

The polyurethane foam according to the present invention having the constitution described above showing the same level of shape and physical properties as the polyurethane foam manufactured from the petroleum-based polyol, particularly by improving the defects of the conventional polyol-based biopolyol polyurethane foam.

Further, the polyurethane foam according to the present invention has an advantage of showing excellent antimicrobial properties, such as reducing Staphylococcus aureus and Klebsiella pneumonia by the unreacted materials contained in the biopolyol.

In addition, when the polyurethane foam according to the present invention is applied to a car seat and the like, there is an effect of improving riding quality by maximally absorbing vibration generated during driving.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A multi-functional bio polyurethane foam comprising a reaction product of a resin premix and isocyanate, wherein the resin premix comprises a biopolyol in an amount of about 5 to 20 wt %.

2. The multi-functional bio polyurethane foam according to claim 1, wherein the isocyanate comprises about 10 to 70 wt % of monomeric methylene diphenyl diisocyanate (MMDI), about 10 to 70 wt % of carbodiimide modified methylene diphenyl diisocyanate, about 10 to 90 wt % of polymeric methylene diphenyl diisocyanate (PMDI) and about 5 to 80 wt % of toluene diisocyanate (TDI) based on the total weight of the isocyanate.

3. The multi-functional bio polyurethane foam according to claim 1, wherein the biopolyol is manufactured from castor oil.

4. The multi-functional bio polyurethane foam according to claim 1, wherein the resin premix further comprises a base polyol in an amount of about 5 to 40 wt %, a high molecular polyol in an amount of about 15 to 55 wt % and a polymer polyol in an amount of about 3 to 40 wt % based on the total weight of the resin premix.

5. The multi-functional bio polyurethane foam according to claim 4, wherein a molecular weight (MW) of the biopolyol is about 2500 to 3500, a molecular weight (MW) of the base polyol is about 5000 to 6000, and a molecular weight (MW) of the high molecular polyol is about 6500 to 7500.

6. The multi-functional bio polyurethane foam according to claim 4, wherein the base polyol and the high molecular polyol are individually one or more selected from the group consisting of polyether polyol, polyester polyol and combinations thereof.

7. The multi-functional bio polyurethane foam according to claim 4, wherein the resin premix further comprises a chain extender in an amount of about 0.1 to 1 wt %, a cross-linker in an amount of more than 0 to less than about 5 wt %, and a silicone surfactant in an amount of about 0.1 to 3 wt % based on the total weight of the resin premix.

8. The multi-functional bio polyurethane foam according to claim 7, wherein the silicone surfactant comprises a first silicone surfactant and a second silicone surfactant, the second silicone surfactant having relatively stronger activity than the first silicone surfactant.

9. The multi-functional bio polyurethane foam according to claim 7, wherein the resin premix further comprises a blowing agent in an amount of about 1 to 5 wt %, a gelling catalyst in an amount of about 0.1 to 3 wt %, and a blowing catalyst in an amount of about 0.1 to 3 wt %.

10. A car seat manufactured from the multi-functional bio polyurethane foam according to claim 1.
